(19) United States
(12) Patent Application Publication
(10) Pub. No.: US 2008/0109453 A1
(43) Pub. Date: May 8, 2008

(54) METHOD AND SYSTEM FOR WEB-BASED GRADE BOOK

(75) Inventor: Warren Bauer, Fort Dodge, IA (US)

Correspondence Address: MCKEE, VOORHEES & SEASE, P.L.C., 801 GRAND AVENUE, SUITE 3200, DES MOINES, IA, 50309-2721, US

(73) Assignee: IOWA CENTRAL COMMUNITY COLLEGE, Fort Dodge, IA (US)

(21) Appl. No.: 11/555,950

(22) Filed: Nov. 2, 2006

(51) Int. Cl. G06F 17/30

(52) U.S. Cl. 707/100; 707/E17.005

(57) ABSTRACT

An electronic grade book is described. The method includes electronically receiving from a student enrollment management system student information and class information wherein the student information includes student names and wherein the class information includes a name of a class and student identifiers for students within the class, receiving from an instructor of the class a selection of an overall grading method for a plurality of categories associated with the class, receiving from the instructor of the class a grading scale, receiving from the instructor of the class a weighting method for each of the plurality of categories associated with the class, receiving from the instructor a plurality of assignment descriptions for assignments, receiving from the instructor a score for each of the students for each of the assignments, calculating a grade for each of the students, and displaying the grade for at least one of the students.

### BACKGROUND OF THE INVENTION

The present invention relates to maintaining a grade book which provides a record of student performance within a class. Grade books are generally known in the prior art. In paper grade books, instructors record student names, assignment information, and scores to track the progress of the student. In addition to paper-based grade books, some electronic grade books are disclosed in the prior art. Such electronic grade books typically automate the paper-based grade books through adding features such as automatically calculating grades from a set of scores. Examples of electronic grade books include U.S. Patent Publication No. 2005/0038807 to Porter, U.S. Patent Publication No. 2006/0046239 to Allen et al., and U.S. Pat. No. 6,678,500 to Helmick et al. Despite the existence of grade books and electronic grade books, problems remain.

### BRIEF SUMMARY OF THE INVENTION

Therefore, it is a primary object, feature or advantage of the present invention to improve over the state of the art.

It is a further object, feature or advantage of the present invention to provide a web-based grade book that reduces the efforts required of an instructor.

It is a still further object, feature or advantage of the present invention to provide an electronic grade book that encourages instructors to have their grades finalized and submitted in a timely fashion.

Another object, feature, or advantage of the present invention is to provide an electronic grade book that is flexible in its application so as to accommodate instructor preferences or institutional preferences in grading.

Yet another object, feature, or advantage of the present invention is to provide a grade book that can be used to track and report on attendance of students for grading purposes or other purposes.

A further object, feature, or advantage of the present invention is to provide a grade book that allows an instructor to report comments in addition to scores.

A still further object, feature, or advantage of the present invention is to provide a grade book that allows a student advisor to access information about advisees so that the student advisor can check or monitor progress of his or her advisees.

Yet another object, feature or advantage of the present invention is to provide an electronic grade book which allows students to access their scores, progress, or grade at any point in time without contacting their instructor.

One or more of these and/or other objects, features or advantages of the present invention will become apparent from the specification and claims that follow.

According to one aspect of the present invention, a method for administering a grade book system is provided. The method provides for electronically receiving from a student enrollment management system, student information, and class information. The student information may include student names, and the class information may include class names and student identifiers associated with the class. The method further includes receiving from an instructor of the class a selection of an overall grade method. The method further includes receiving from the instructor the grading scale and receiving from the instructor of a class a weighting methodology for each of a number of categories. The method further includes receiving from the instructor a number of assignment descriptions for assignments associated with the class. The method includes receiving from the instructor a score for each of the students for each of the assignments. The method contemplates that the score may be a zero or a blank if the student did not perform each of the assignments. The method further includes calculating a grade for each of the students and displaying the grade for each of the students. The method allows for the overall grading method to take into consideration different categories of assignments. Examples of categories may include class work, clinicals, discussion, essays, finals, forms, homework, investigation, labs, midterms, papers, participation, performances, presentations, projects, quizzes, readings, reviews, seat work, tests, and instructor-defined categories. The weighting method may be of various types. In addition, access to each of the student's may be provided so that each of the students can view their own scores for each of the assignments.

### BRIEF DESCRIPTION OF THE DRAWINGS

FIG. 1 is a block diagram showing an overview of one system of an electronic grade book.

FIG. 2 is a pictorial representation of a login screen display according to one embodiment of the present invention.

FIG. 3 is a pictorial representation of a screen display of a main menu according to one embodiment of the present invention.

FIG. 4 is a pictorial representation of a one embodiment of a menu the faculty using a grade book system.

FIG. 5 is a pictorial representation of one embodiment of a screen display allowing an instructor to select a term.

FIG. 6 is a pictorial representation of one embodiment of a screen display to allow an instructor to select a course.

FIG. 7 is a pictorial representation of one embodiment of a screen display for a course using one embodiment of a grade book system.

FIG. 8 is a pictorial representation of one portion of a screen display which allows an instructor to select an overall grading method and provides an explanation of the different types of overall grading methods.

FIG. 9 is a pictorial representation of a portion of a screen display which allows an instructor to set the minimum percents associated with various letter grades.

FIG. 10 is a representation of a portion of a screen display which allows an instructor to specify the manner in which different categories of work are graded.

FIG. 11 is a representation of a portion of a screen display which allows an instructor to define categories of work and determine their effect on overall grading.

FIG. 12 is a portion of a screen display which allows an instructor to determine the sections to include with the grade book.

FIG. 13 is a representation of one embodiment of a screen display showing course information.

FIG. 14 is a representation of one embodiment of a screen display showing course information.

FIG. 15 is a representation of one embodiment of a screen display showing assignment information including scoring and comments to students.

FIG. 16 is one embodiment of the portion of a screen display allowing an instructor to select different screens.

FIG. 17 is one embodiment of a screen display showing performance of students in the classes on various assignments.

FIG. 18 is a representation of one embodiment of a portion of a screen display showing student information.

FIG. 19 is a representation of one embodiment of a screen display showing attendance for various students.

FIG. 20 is a portion of one embodiment of a screen display showing attendance records for various students.

FIG. 21 is a representation of one embodiment of a screen display showing a summary of grading and attendance information according to one embodiment of the present invention.

FIG. 22 is a pictorial representation of one embodiment of a grade book report for a student.

FIG. 23 is a block diagram showing one embodiment of a grade book system and its interaction with a student enrollment management system according to one embodiment of the present invention.

### DETAILED DESCRIPTION OF THE PREFERRED EMBODIMENT

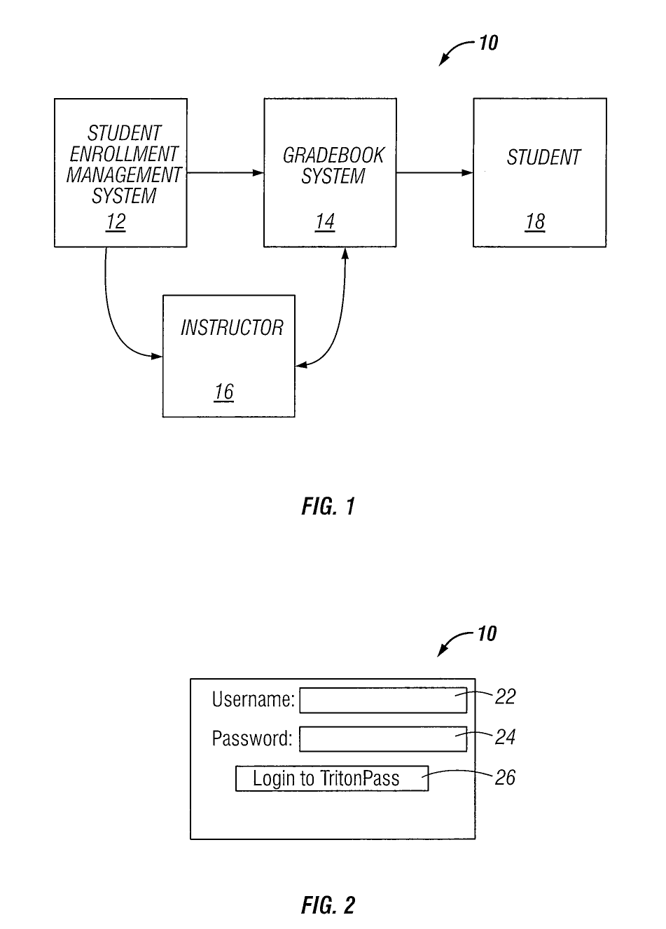

The present invention relates to a grade book system. FIG. 1 shows an example of the information flow associated with one embodiment of a grade book system. In FIG. 1, a system 10 includes a student enrollment management system 12 in operative communication with the grade book system 14. An instructor 16 can interact with the grade book system 14 and a student 18 can receive information from the grade book system 14. Thus, it is to be understood that the grade book system 14 can be populated with instructor, class, and student information from the student enrollment management system 12. One example of a student enrollment management system is Colleague available from Datatel, Inc. Where Colleague is used, the grade book system may be implemented in the Envision language used in Colleague. Of course, as would be recognized by one skilled in the art, the grade book system may be implemented in numerous languages using many different types of development tools, and may be developed using various different platforms. Thus, the instructor 16 need not independently provide this type of information to the grade book system 14. The instructor 16 interacts with the grade book system 14 to provide information regarding how the instructor grades the class, attendance information, and related information which will be discussed in greater detail. In addition, the student 18 can access the grade book system 14 for the purpose of viewing their own grade or attendance information. The interaction with the student enrollment management system 12 provides a number of advantages. In particular, the instructor 16, in order to manage their classes with the grade book system 14 need not re-enter course information, student information and related information. In addition, at the end of the class or at reporting periods associated with the class, the student enrollment management system 12 can access the grade book system 14. Thus, an instructor 16 need not spend time or effort re-entering grading information into a system different from what they use to track or compute student grades. This reduces the likelihood of any data entry errors which may affect student grades while also providing increased convenience and time savings for the instructor. This may also result in more timely reporting of the grades by the instructor. In addition, note the benefit to the student 18 who can access the grade book system 14 and independently check their grade, scores, attendance, or other information. Thus, the student 18 need not maintain a separate accounting of their progress in the class. The student 18 also need not directly contact the instructor 16 to determine their progress in the class nor does the instructor receive inquiries from the students in the class and need to respond to the inquiries regarding their grades. Thus, the present invention may be used to save time for both the instructor and the student and may also encourage the student to more frequently check their progress in their classes. It is to be understood that the grade book system 14 provide numerous and significant benefits to the student, the instructor, and the institution.

FIG. 2 illustrates a login screen display 20. The login screen display 20 includes a field 22 in which a user enters their user name and a field 24 in which the user enters their password. Upon completing this information, the user may select to login by selecting the login button 26. Of course, the present invention contemplates that a user may login in a number of other appropriate manners.

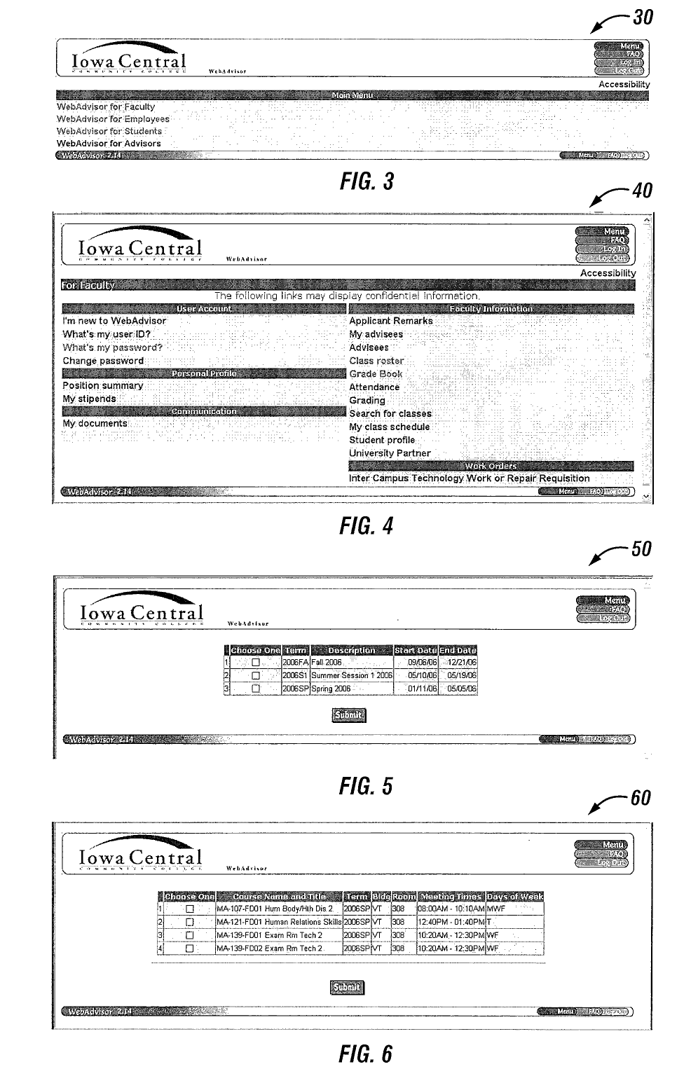

FIG. 3 illustrates a main menu 30. Note that the present invention contemplates that faculty, employees, students, and advisors are assigned varying levels of access to the system. For example, faculty members are allowed to determine grading methodologies for the classes and provide grades. Employees may be allowed to enter grades on behalf of an instructor. For example, a departmental administrative assistant or a teaching assistant, or grader may be able to enter grades on behalf of an instructor. Students are allowed to check their own grades. Advisors are allowed to check the progress of their advisees. Of course, the level of access provided to any of these categories of individuals or others is dependent upon the features they need to access.

FIG. 4 provides one embodiment of a screen display 40 for a faculty member. One of the selections for the faculty is “grade book”. FIG. 5 is one embodiment of a screen display 50 that allows the selection of a term. A faculty member may select the term associated with a course and section they wish to access. FIG. 6 is one embodiment of a screen display of the present invention that allows for the selection of a course. Each course may have one or more sections.

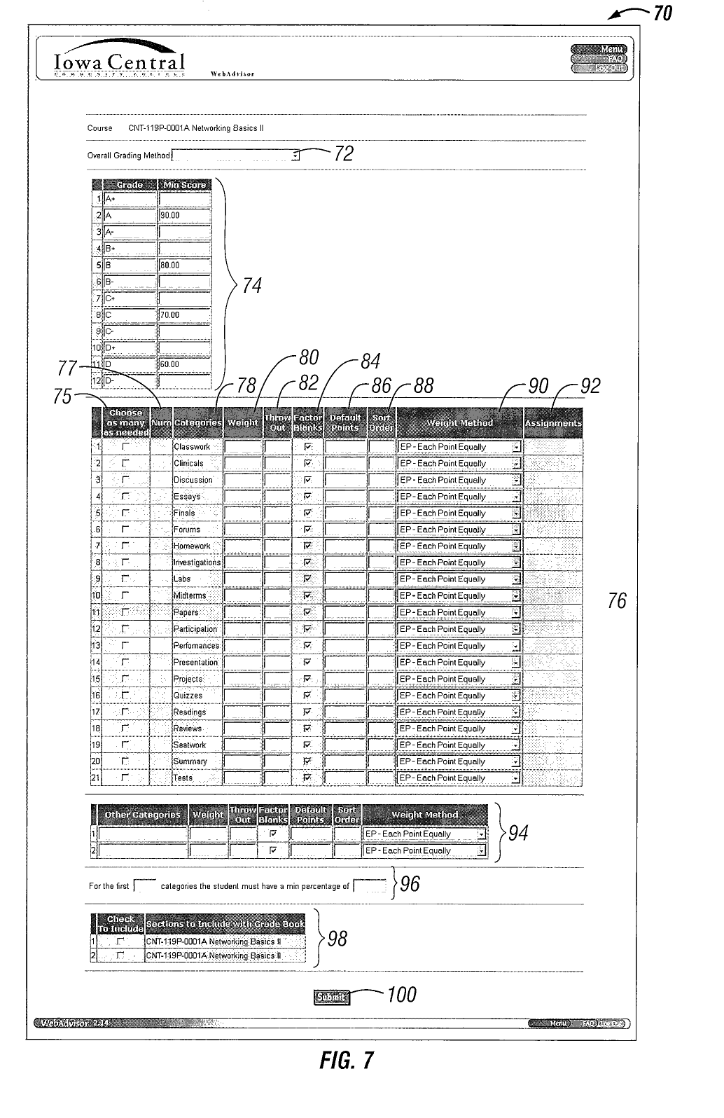

FIG. 7 is one embodiment of a screen display for a course. A faculty member uses a drop down list box 72 to select an overall grading method for the course. In addition, the faculty member or instructor can use the region 74 of the screen display 70 to associate letter grades with minimum scores. The region 76 of the screen display 70 allows a faculty member or instructor to determine the categories they choose to use in grading and related information for each category. There is a column 75 for an instructor to indicate the categories the instructor wishes to use. There is a column 77 which shows the number assigned to the category for each type of category they wish to use. Column 78 provides a name for each of the categories. Column 80 provides for the instructor to enter the weight they wish to assign to each of the categories. Column 82 allows an instructor to indicate the number of assignments they wish to throw out. Column 84 allows an instructor to select whether they wish to factor blanks into the scoring. Column 86 allows an instructor to enter the default points. Column 88 allows an instructor to enter sort order for each category. Column 90 allows an instructor to provide a weighting method for each category. Column 92 shows the number of assignments entered in each category.

In addition to the categories provided in column 78, a faculty member or instructor may enter additional user-defined categories using region 94 of the screen display 70. Also, region 96 allows an instructor to enter information if they would like a first number of categories for a student to have a minimum percentage. The instructor may set the number of categories and the minimum percentage they would like the students to have. In addition, where a course has multiple sections, the instructor can select the sections they wish to include with the grade book using the portion of the screen display 98. Once completed, the instructor may select the submit button 100.

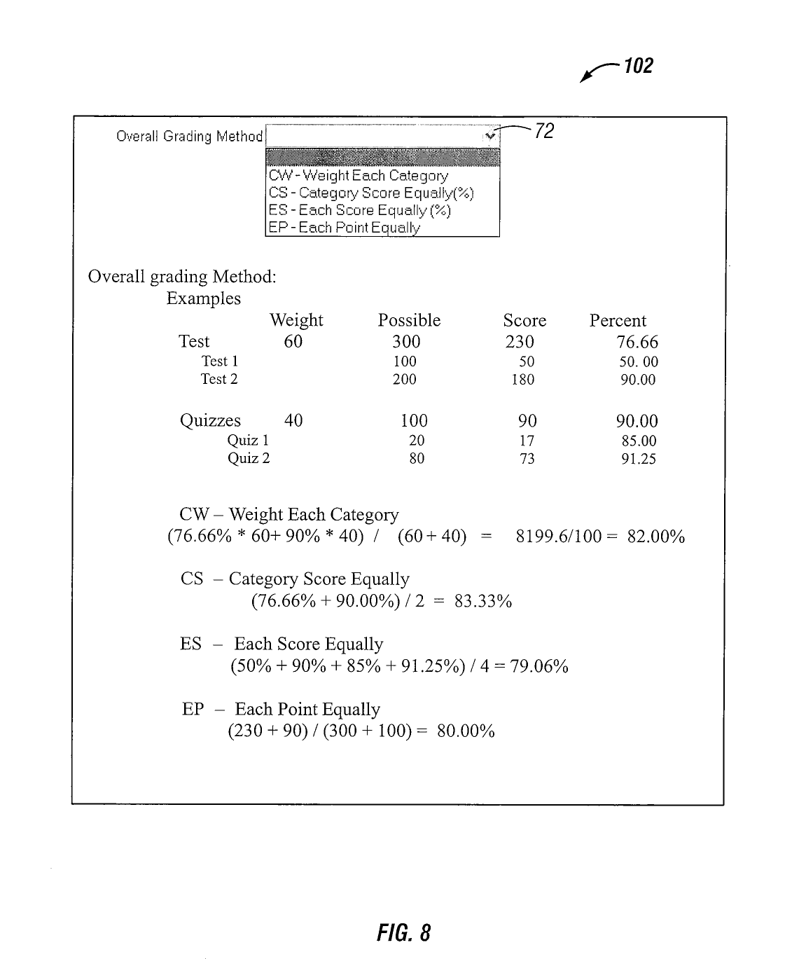

FIG. 8 shows one embodiment of the screen display 102 with a drop down list box 72 from which an instructor can select an overall grading methodology. Examples of the type of grading methodology can include a Weight Each Category (CW) overall grading method, a Category Score Equally (%) (CS) grading methodology, Each Score Equally (%) (ES) overall grading methodology, and an Each Point Equally (EP) overall grading methodology. The manner in which these different categories can be applied is provided through the illustration of representative examples. It is to be understood that the present invention is not to be limited to these grading methodologies as other grading methodologies may be implemented.

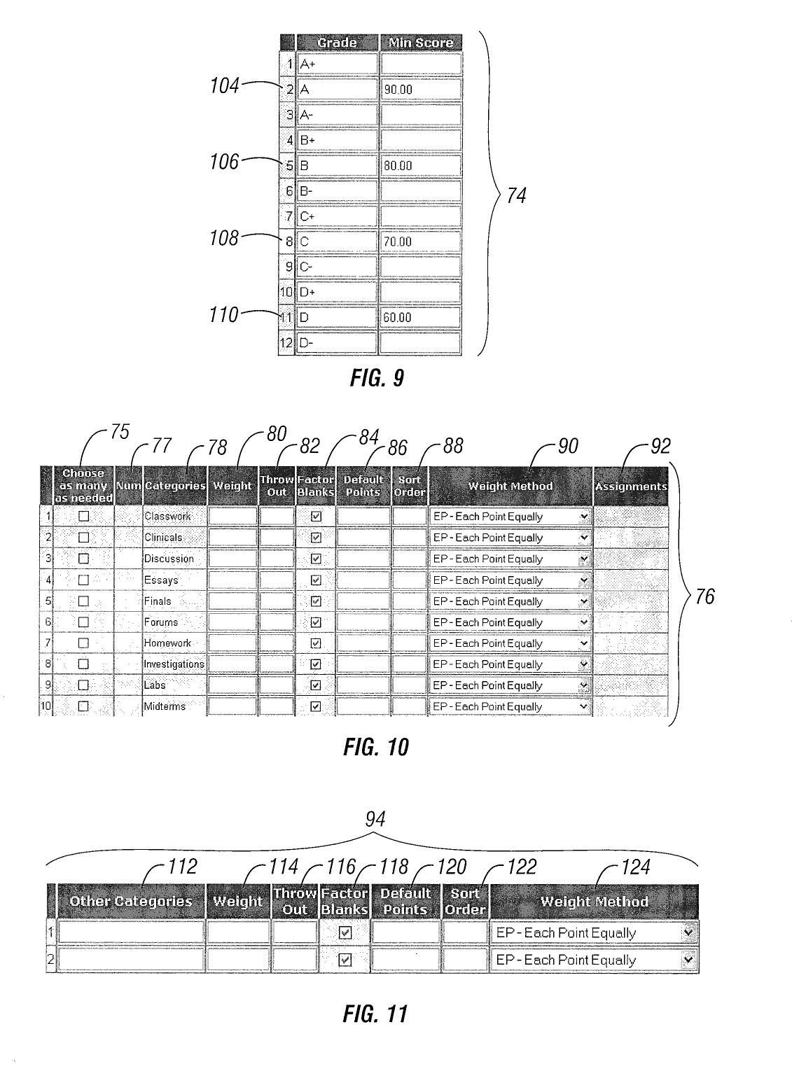

FIG. 9 illustrates the portion 74 of a screen display which allows an instructor to associate minimum scores with grades. Note that in FIG. 9, a letter grade of “A” requires a minimum score of 90.00 as shown in row 104. A grade of “B” requires a minimum score of 80.00 as shown in row 106. A grade of “C” requires a minimum score of 70.00 as shown in row 108. A grade of “D” requires a minimum score of 60.00 as shown in row 110. An instruction can modify the minimum scores necessary for each grade. If the institution reports grades with pluses and minuses, than the instruction can also enter or modify the minimum scores necessary to receive a plus or minus for each grade.

FIG. 10 illustrates portion 76 of screen display allowing an instructor or faculty member to select the categories that they wish to use as well as associated information. FIG. 11 provides a region of the screen display 94 where an instructor or faculty member can define additional categories. There is a column 112 for the other categories, column 114 for weight, column 116 for throw out, column 118 for citing a preference regarding whether blanks are factored, column 120 for setting default points, column 122 for setting sort order, and column 124 for setting the weight method.

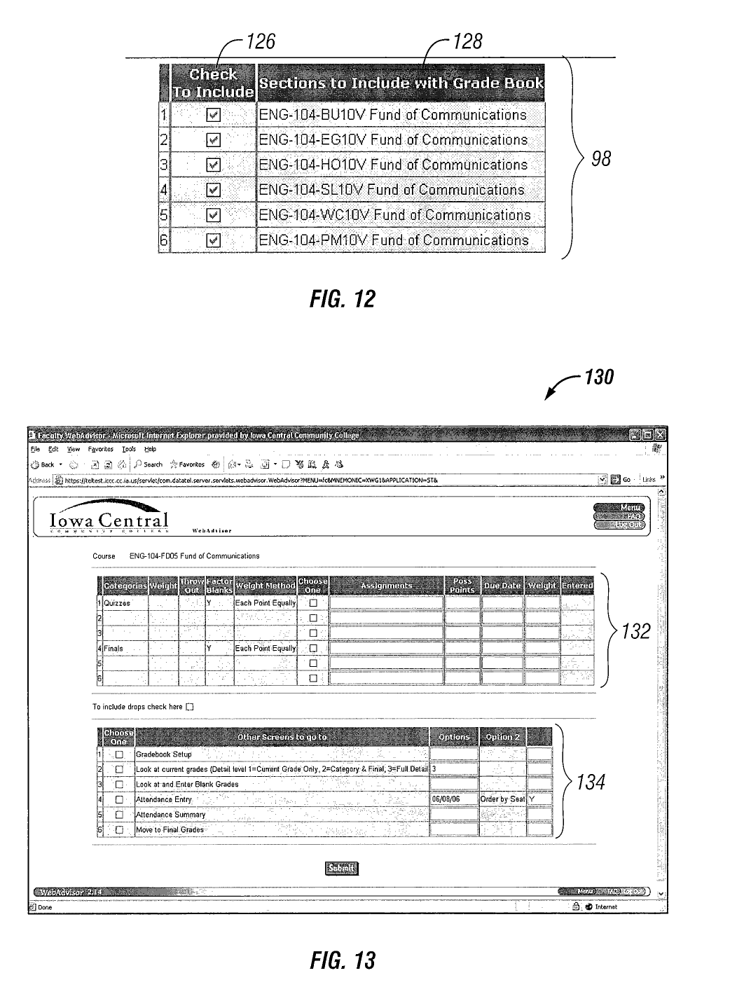

FIG. 12 illustrates a portion of screen display 98 where multiple sections are listed and an instructor can select the sessions which the instructor wishes to include within the grade book by checking boxes in column 126 corresponding with sessions listed in column 128. FIG. 13 provides a screen display 130 which includes a region 132 showing the categories associated with a particular course as well as the assignments associated with each category. A portion 134 of the screen display 130 provides the instructor with other options including but not limited to grade book setup, looking at current grades, looking at and entering blank grades, attendance entry, attendance summary, move to midterm, and move to final grades.

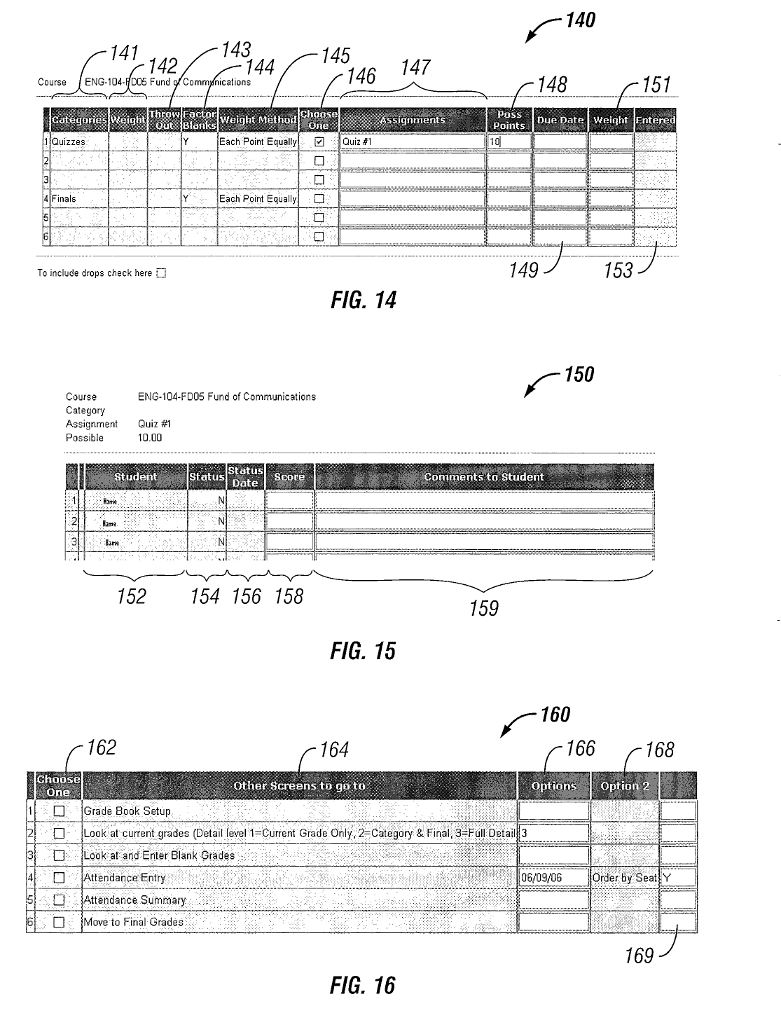

FIG. 14 provides a portion of a screen display. As shown in FIG. 14, there is a column 141 for categories, column 142 for weights, column 143 for throw out, column 144 where instructor has indicated whether blanks are factored or not, column 145 indicating the weighting method, column 146 indicating the selection of one of the assignments for score entry, column 147 providing a description of an assignment, column 148 for providing the possible points associated with an assignment, column 149 for indicating the due date associated with an assignment, column 151 for indicating a weight associated with an assignment, and column 153 for indicating the number of scores that have been entered for the assignment.

FIG. 15 provides portion 150 of a screen display showing the results of a class for a particular assignment. There is a column 152 for student names, column 154 for status of the student, column 156 for status date, column 158 for score, and column 159 for instructor to provide comments to each student.

FIG. 16 shows a portion 160 of a screen display having a column 162 allowing the instructor to choose a row, column 164 indicative of other screens the instructor may go to, column 166 providing for options, column 168 providing for additional option descriptions, and column 169 for providing additional options.

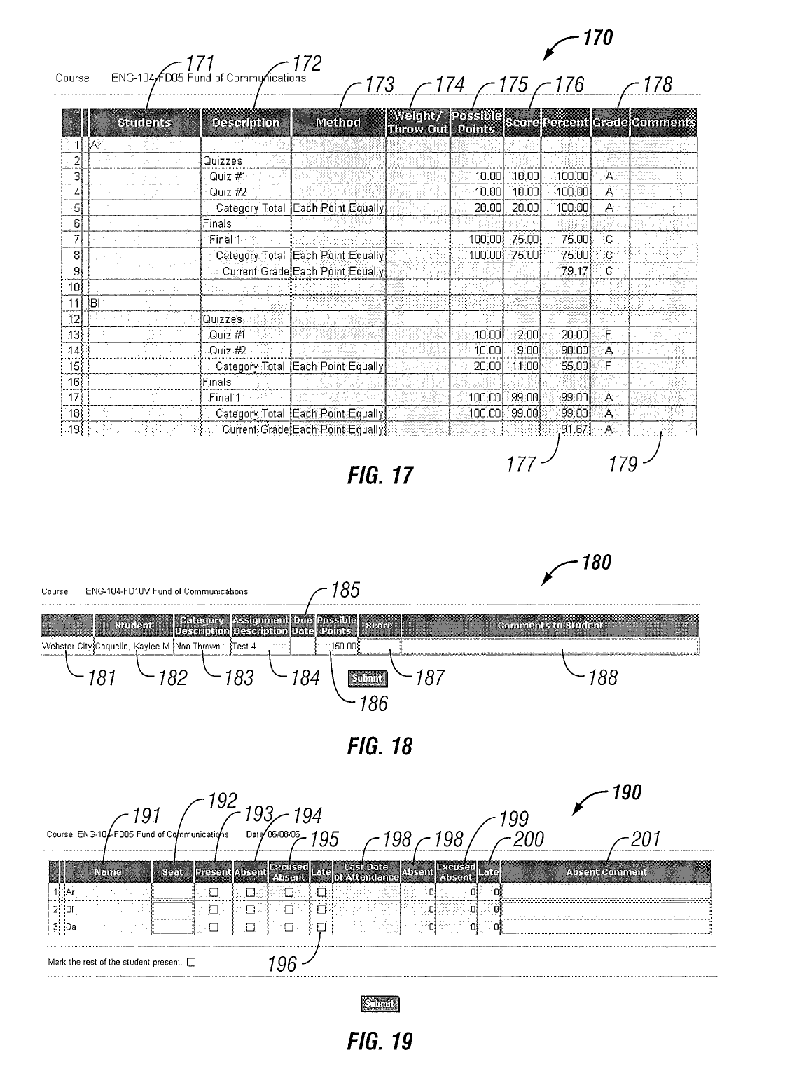

FIG. 17 provides a portion 170 of a screen display having a column 171 for students, column 172 for a description, column 173 for a method, column 174 for weight/throw out, column 175 for possible points, column 176 for score, column 177 for percent, column 178 for grade, and column 179 for comments. Thus, the instructor can look at the screen display 170 and see the progress of the students in the class based on their scores for different assignments.

FIG. 18 provides a screen display 180 showing all blank grades for a class. There is a column 181 for city where the student is taking the class, column 182 for student name, column 183 for a category description, column 184 for an assignment description, column 185 for a due date, column 186 for possible points, column 187 for a score, and column 188 for comments to the student.

FIG. 19 includes a screen display 190 showing attendance information associated with the students in the class. Column 191 for student names, column 192 for seat assignment for each student, column 193 for indicating whether a student is present on the date, column 194 for indicating whether a student is absent on a date, column 195 for indicating whether the absence is excused, column 196 for indicating whether a student is late, column 197 for indicating the last date of attendance for this student, column 198 indicating the number of absences associated with the student, column 199 indicating the number of excused absences associated with a student, column 200 indicating the number of times a student has been late, and column 201 in which an instructor indicates comments regarding the absence.

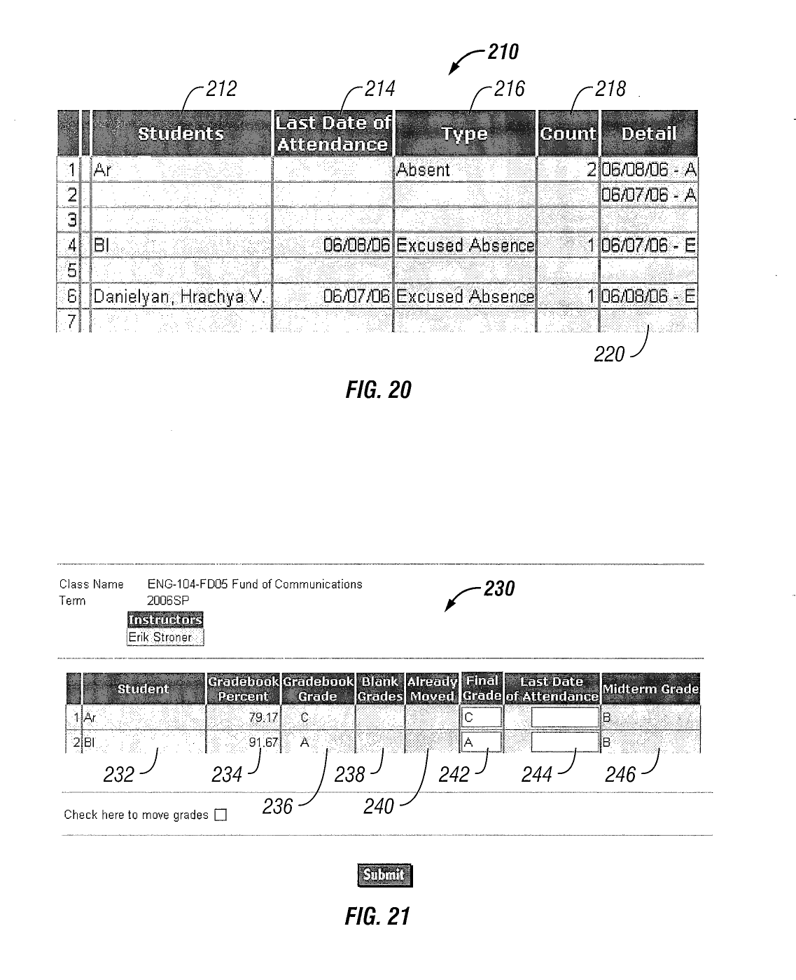

FIG. 20 provides a portion of a screen display 210 having a column 212 for student names, column 214 for last date of attendance, column 216 for type of absence such as absent or excused absence, column 218 for the number of times the student has had such absence, and column 220 indicating additional details such as the date of the absence and whether the absence was excused or not.

FIG. 21 provides a screen display 230 for a class including a column for student names 232, column 234 for grade book percentage, column 236 for grade book grade, column 238 indicates the number of blank grades for a student, column 240 indicates if the grade is already in the student enrollment management system, column 242 for final grade, column 244 for last date of attendance, and column 246 for midterm grade.

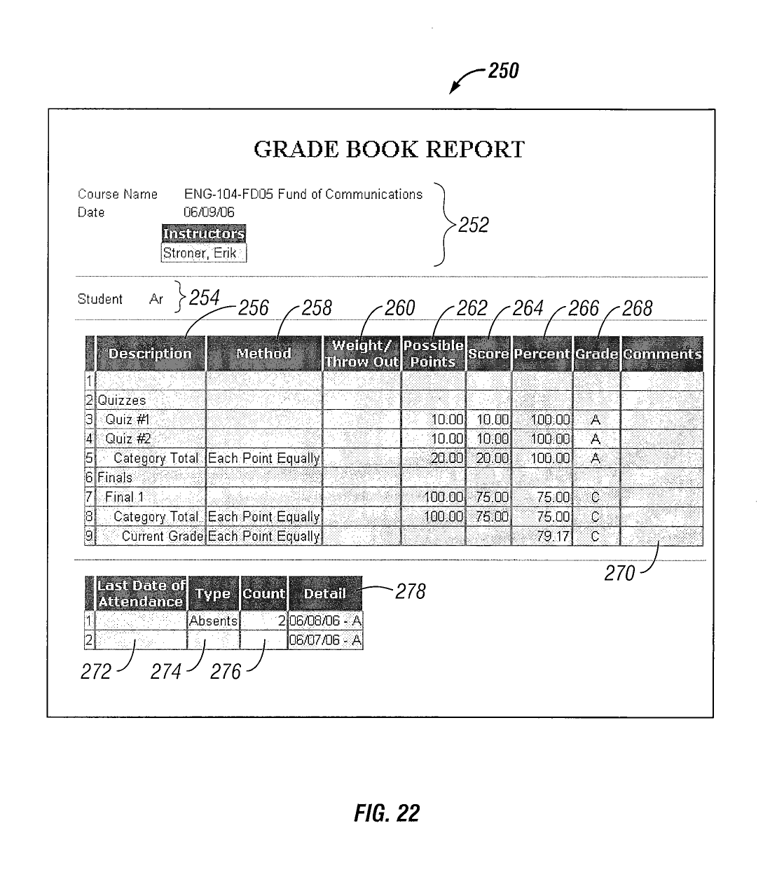

FIG. 22 provides a screen display 250 of a student's grade book report. Course information including course name and day is provided in region 252. Student name or other student information is provided in region 254. A number of columns are presented for each student which provides a description of categories and assignments 256, a method for grading 258, column 260 indicating whether the grade is weighted or thrown out, column 262 showing possible points, column 264 showing a score, column 266 showing a percent, column 268 showing a grade, and column 270 showing comments. In addition, attendance information is shown on this report, including a column for last date of attendance 272, column 274 for type of absence, column 276 for the number of absences, and column 278 providing details regarding absences.

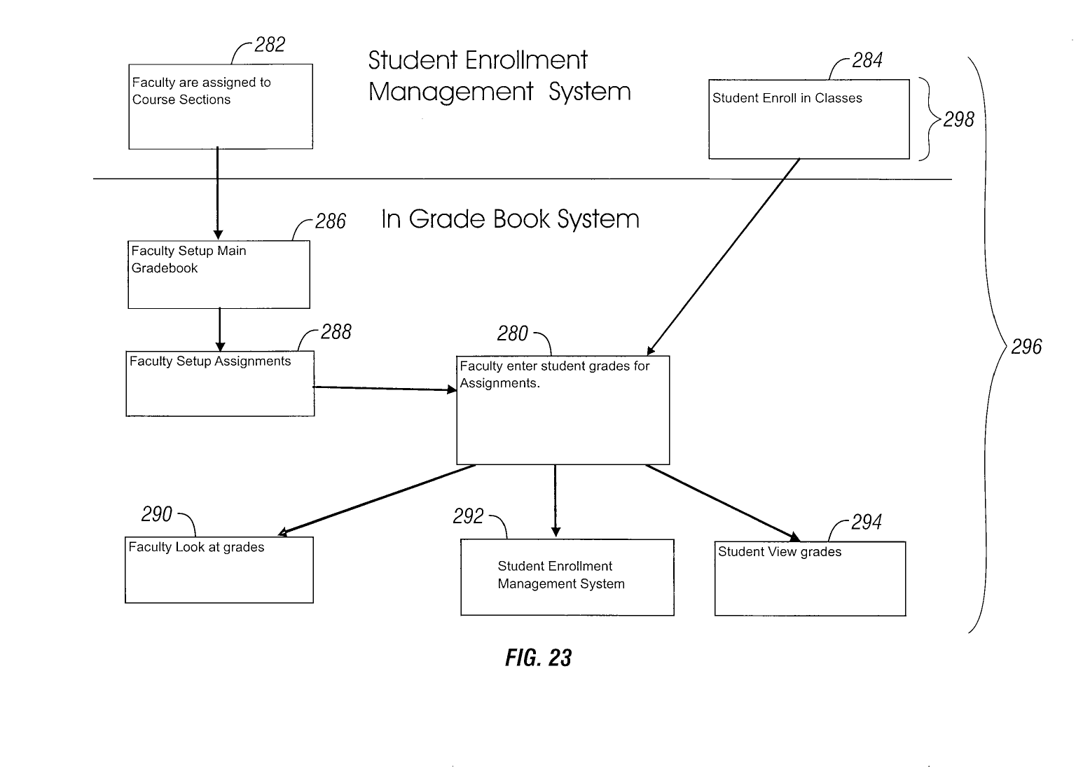

FIG. 23 provides an overview of one embodiment of a grade book system of the present invention. In FIG. 23, grade book system 296 provides for interaction with a student enrollment management system 298. In step 282, faculty members are assigned to course sections by the student enrollment management system 298. In step 284, students enroll in the classes. In step 286, faculty members setup their main grade book. This includes the manner in which student scores are calculated, including the weight given to different categories of work performed by the student. In step 288, faculty setup individual assignments. In step 280, faculty enters student grades for the assignments as well as notes where appropriate. In step 290, faculty can examine the grades. In step 294, students can view the grades. In step 292, the faculty can move the final grades into the student enrollment management system.

The present invention contemplates numerous variations, options, and alternatives. For example, the system can allow for organizing information in various ways either on screen or in printed reports. Thus, for examples, an instructor may want to see the scores of all students for a particular assignment or an average score for all students taking a course for a particular assignment or set of assignments. In addition, an instructor may want to print a listing of all students in a course in case the instructor wants to record by hand the scores for a particular assignment and then later enter the scores or have the scores entered by someone else into the grade book. These and numerous other variations, options, and alternatives are well within the spirit and scope of the claimed invention.

What is claimed is:

1. A method for administering a grade book system, comprising:
electronically receiving from a student enrollment management system student information and class information wherein the student information includes student names and wherein the class information includes a name of a class and student identifiers for students within the class;
receiving from an instructor of the class a selection of an overall grading method for a plurality of categories associated with the class;
receiving from the instructor of the class a grading scale;
receiving from the instructor of the class a weighting method for each of the plurality of categories associated with the class;
receiving from the instructor a plurality of assignment descriptions for assignments;
receiving from the instructor a score for each of the students for each of the assignments;
calculating a grade for each of the students; and
displaying the grade for at least one of the students.

2. The method of claim 1 wherein the categories include at least one category from the set consisting of class work, clinicals, discussion, essays, finals, forums, homework, investigations, labs, midterms, papers, participation, performances, presentations, projects, quizzes, readings, reviews, seatwork, and tests.

3. The method of claim 1 wherein the weighting method is from the set consisting of weight each category, category score equally, each score equally, and each point equally.

4. The method of claim 1 further comprising receiving from the instructor comments for one of the students associated with one of the assignments.

5. The method of claim 1 further comprising electronically providing access to each of the students to view the score for each of the assignments.

6. The method of claim 1 wherein the step of displaying the grade for at least one of the students is performed using a web site.

7. The method of claim 1 further comprising electronically providing access to an advisor of at least one of the students in the class for reviewing performance of the at least one of the students in the class.

8. An article of software for performing grade book functions, the article of software stored on a computer readable medium and comprising instructions adapted for performing the steps of electronically receiving from a student enrollment management system student information and class information wherein the student information includes student names and wherein the class information includes a name of a class and student identifiers for students within the class, receiving from an instructor of the class a selection of an overall grading method for a plurality of categories associated with the class, receiving from the instructor of the class a weighting method for each of the plurality of categories associated with the class, receiving from the instructor a plurality of assignment descriptions for assignments, receiving from the instructor a score for each of the students for each of the assignments, calculating a grade for each of the students, and displaying the grade for at least one of the students.

9. A system for an online grade book, comprising:
means for electronically communicating with a student enrollment management system for receiving class information including class names and student names from the student enrollment management system and for sending final grades to the student enrollment management system;
at least one setup screen accessible by a faculty member for setting up the online grade book for that class by setting an overall grading method for a plurality of categories associated with the class, grading scale for the class, and a weighting method for each of the plurality of categories associated with the class; and
at least one report screen accessible by a student for viewing performance of the student.

10. The system of claim 9 further comprising at least one advisor report screen accessible by a student advisor for viewing performance of one or more students advised by the student advisor.

11. The system of claim 9 further comprising at least one assignment screen accessible by the faculty member for entering assignment information.

12. The system of claim 11 wherein the assignment information includes student scores for the assignments.

13. The system of claim 12 wherein the assignment information further includes faculty comments for students regarding the student scores.

14. The system of claim 9 wherein the categories include at least one category from the set consisting of class work, clinicals, discussion, essays, finals, forums, homework, investigations, labs, midterms, papers, participation, performances, presentations, projects, quizzes, readings, reviews, seatwork, and tests.

15. The system of claim 9 wherein the weighting method is from the set consisting of weight each category, category score equally, each score equally, and each point equally.
